(19) United States
(12) Patent Application Publication
(10) Pub. No.: US 2012/0140471 A1
(43) Pub. Date: Jun. 7, 2012

(54) LED LAMP

(75) Inventor: PING-JUNG TSAI, Chu-Nan (TW)

(73) Assignee: FOXSEMICON INTEGRATED TECHNOLOGY, INC., Chu-Nan (TW)

(21) Appl. No.: 13/285,000

(22) Filed: Oct. 31, 2011

(30) Foreign Application Priority Data
Dec. 1, 2010 (TW) 099141660

(51) Int. Cl. F21V 21/00; F21V 17/00

(52) U.S. Cl. 362/249.02; 362/375

(57) ABSTRACT

An LED Lamp is disclosed. The LED lamp comprises a hollow housing having a receiving space inside the hollow housing, the hollow housing further comprising a plurality of slots on a circumferential surface of the hollow housing; an LED module configured to fit inside the receiving space of the hollow housing; and a lamp cover configured to be securely fitted inside the hollow housing and provide coverage to the LED module.

### BACKGROUND

1. Technical Field

The present disclosure generally relates to illumination devices, and particularly to lamps having light emitting diodes’ (“LEDs”) as light sources.

2. Description of the Related Art

Conventional lamps generally utilize fluorescent or incandescent lighting sources. Fluorescent or incandescent lamps typically require filaments or cathode tubes for operation. Thus, conventional lamps may be fragile and may have relatively short operating life.

Light emitting diodes (LEDs) may have many advantages, such as high luminosity, low operational voltage, low power consumption, compatibility with integrated circuits, faster switching, long term reliability, and environmental friendliness. These advantages may have promoted the wide usage of LEDs as light sources. A conventional light emitting diode lamp (“LED lamp”) may include a base, and LED module mounted on the base, and a lamp cover placed on the base and covering the LED module. However, the lamp cover is generally made of a transparent or semitransparent material such as glass, resin or plastic, so the lamp cover may be fragile under external forces.

Therefore, it is desirable to provide an LED lamp to overcome the above-described shortcomings.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, assembled view of an LED lamp in accordance with an exemplary embodiment of the present disclosure.

FIG. 2 is an exploded view of the LED lamp of FIG. 1.

FIG. 3 is an inverted, exploded view of the LED lamp of FIG. 1.

### DETAILED DESCRIPTION

An embodiment of an LED lamp as disclosed is described in detail here with reference to the drawings.

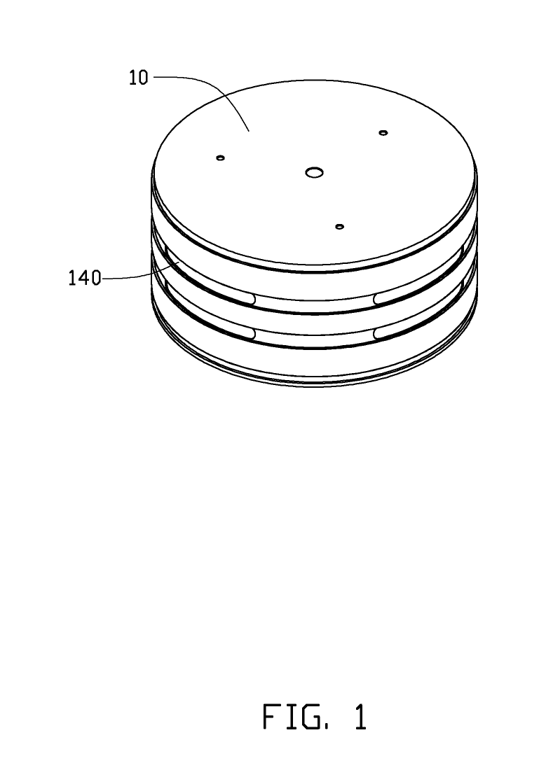

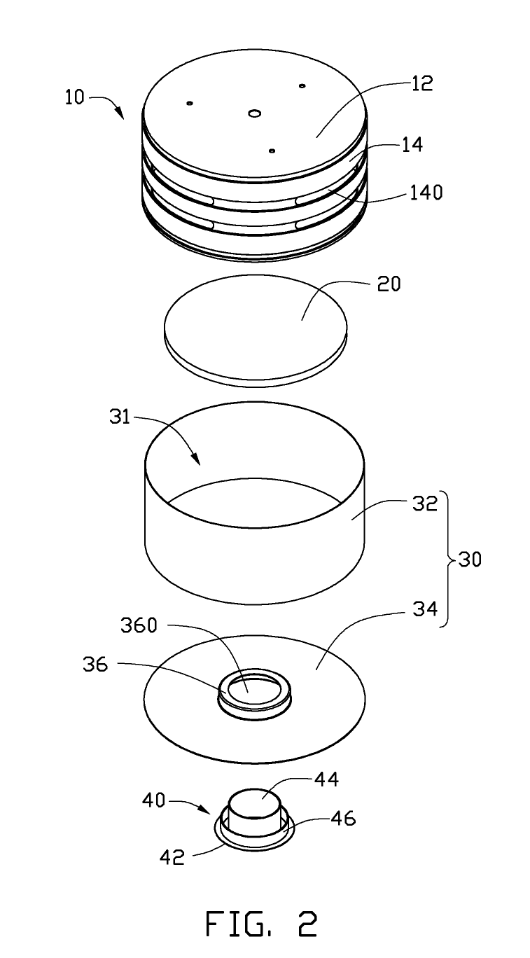

Referring to FIGS. 1-2, an LED lamp in accordance with an exemplary embodiment of the disclosure may comprise a hollow housing 10, an LED module 20 placed inside a receiving space 11 of the hollow housing 10, a lamp cover 30 received in the hollow housing 10, and a fixing member 40 fixed to the lamp cover 30.

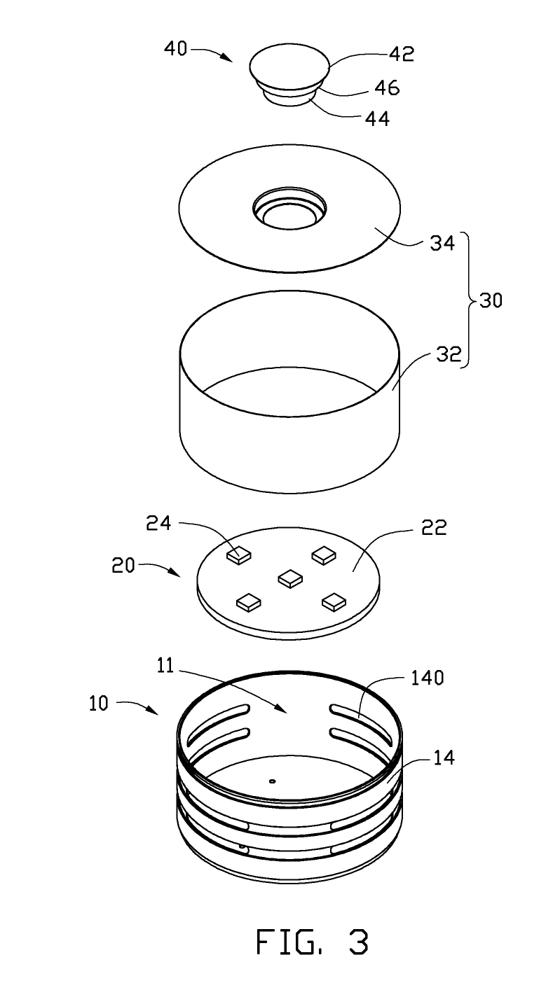

Referring to FIG. 3 also, the hollow housing 10 may has a barrel-like configuration with the receiving space 11, which has an opening on one end of the hollow housing 10. In one embodiment of the present disclosure, the hollow housing 10 may be made of metal with high heat conductivity, such as aluminum, steel, iron, copper, or an alloy thereof, whereby the housing 10 may also function as a heat sink. The hollow housing 10 may comprise a circular top plate 12 and a cylindrical sidewall 14 integrally extending from an outer periphery of the circular top plate 12 to form the opening. A plurality of elongated slots 140 may be cut through the cylindrical sidewall 14. The plurality of slots 140 may be spaced from each other and arranged evenly on the cylindrical sidewall 14. The plurality of slots 140 may extend along a circumferential direction of the cylindrical sidewall 14. In one embodiment, the plurality of slots 140 may be divided into two groups at two different levels wherein each group of plurality of slots 140 includes four slots equidistantly spaced from each other and concentrically located on a circumferential surface of the cylindrical sidewall 14.

Referring to FIG. 3, the LED module 20 may include a circular printed circuit board 22 and a plurality of LEDs 24 mounted on the printed circuit board 22. The printed circuit board 22 may be placed inside the receiving space 11 with the plurality of LEDs 24 facing the opening end of the hollow housing 10. The opposite side of the plurality of LEDs 24 of the printed circuit board 22 may be thermally attached to the circular top plate 12 of the hollow housing 10. The plurality of LEDs 24 are spaced from each other and arranged evenly on the printed circuit board 22. The printed circuit board 22 provides integral support and electrical connection to the plurality of LEDs 24.

Referring to FIG. 2, the lamp cover 30 may be a barrel-like configuration with an opening 31 on one end and a circular bottom plate 34 on the opposite end of the opening 31. In one embodiment, the lamp cover 30 may be made of a transparent or semitransparent material such as glass, resin, or plastic. The lamp cover 30 may comprise the circular bottom plate 34, and a cylindrical lateral wall 32 engaging with an outer periphery of the bottom plate 34. The lamp cover 30 may be fitted inside the receiving space 11 of the hollow housing 10 with the opening 31 facing the circular top plate 12 of the hollow housing 10. The lateral wall 32 of the lamp cover 30 may has a matching shape as the cylindrical sidewall 14 of the hollow housing 10; but with a smaller size than the sidewall 14 so that the lateral wall 32 is securely fitted inside the cylindrical sidewall 14 of the hollow housing 10. The circular bottom plate 34 may provide coverage to the receiving space 11 of the hollow housing 10 with the LED module 20 enclosed therein. A central portion of the cylindrical bottom plate 34 may be protruded inward to form a cylindrical engaging portion 36. The cylindrical engaging portion 36 may comprise a through hole 360.

Still referring to FIG. 2, the fixing member 40 may include a circular base 42; a column 44 extending perpendicularly from a center of the circular base 42; and a flange 46 extending perpendicularly from the circular base 42 and encircling the column 44. The fixing member 40 may be attached to the circular bottom plate 34 of the lamp cover 30 through the through hole 360 so that the column 44 extends to the LED module 20, and the flange 46 is fitted tightly against the engaging portion 36 of the circular bottom plate 34 of the lamp cover 30. According to present embodiments, the LED lamp may be fixed to a wall or a ceiling by attaching the top circular plate 12 to the wall or the ceiling. In such application, the LED lamp may be used as a ceiling light or a wall light and the cylindrical side wall 32 may be made of an aluminum sheet so that the light generated by the plurality of LEDs 24 radiates out of the lamp through the bottom plate 34 only. The LED lamp may also be fixed on a supporting member (not shown) by securely attaching the circular base 42 of the fixing member 40 to the supporting member. In such application, the LED lamp may be used as a table lamp, wherein the cylindrical side wall 32 may be made of PMMA (Polymethylmethacrylate), whereby the light radiates out of the LED lamp not only through the bottom plate 34 but also through the plurality of slots 140.

In use, the lamp cover 30 and the hollow housing 10 together may provide protections to the LED module 20 against dust and dirt. The hollow housing 10 may also provide additional protections to the lamp cover 30 against external forces. The plurality of slots 140 of the hollow housing 10 are configured for radiating light emitted by the LED module 20 out of the LED lamp. Thus, the LED module 20 of the LED lamp may generate light that radiates along multiple directions, i.e., along the cylindrical direction and the radial directions, to thereby providing a large area of illumination, according to embodiments of the present disclosure.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. An LED lamp, comprising:
a hollow housing having a receiving space inside the hollow housing, the hollow housing further comprising a plurality of slots on a circumferential surface of the hollow housing;
an LED module configured to fit inside the receiving space of the hollow housing; and
a lamp cover configured to be securely fitted inside the hollow housing and provide coverage to the LED module.

2. The LED lamp of claim 1, wherein the hollow housing has a barrel-like configuration having an open end, and the hollow housing further comprises a circular top plate and a cylindrical sidewall extending from an outer periphery of the circular top plate.

3. The LED lamp of claim 2, wherein the plurality of slots are cut through the cylindrical sidewall, and the plurality of slots extend along a circumferential direction of the cylindrical sidewall.

4. The LED lamp of claim 3, wherein the plurality of slots are evenly arranged on the cylindrical sidewall.

5. The LED lamp of claim 2, wherein the plurality of slots are spaced from each other.

6. The LED lamp of claim 2, wherein the LED module comprises a printed circuit board having a plurality of LEDs mounted on one side of the printed circuit board, and the printed circuit board is attached to the top circular plate on an opposite side of the plurality of LEDs.

7. The LED lamp of claim 6, wherein the plurality of LEDs are evenly arranged on the printed circuit board.

8. The LED lamp of claim 2, wherein the lamp cover has a barrel-like configuration having an open end.

9. The LED lamp of claim 8, wherein the lamp cover comprises a circular bottom plate, and a cylindrical lateral wall extending from an outer periphery of the circular bottom plate.

10. The LED lamp of claim 9, wherein the circular lateral wall is configured to securely fitted inside the cylindrical sidewall of the hollow housing.

11. The LED lamp of claim 9, wherein the bottom plate of the lamp cover is configured to cover the receiving space of the hollow housing.

12. The LED lamp of claim 11, wherein light emitted from the LED module is radiated outwardly from the bottom plate of the lamp cover and the plurality of slots of the housing.

13. The LED lamp of claim 11, wherein light emitted from the LED module is radiated outwardly from the bottom plate of the lamp cover only when the LED lamp is used as a ceiling lamp.

14. The LED lamp of claim 1, wherein the housing is made of aluminum, steel, iron, or copper.

15. The LED lamp of claim 1, wherein the lamp cover is made of a transparent or semitransparent material.
